(19) United States
(12) Patent Application Publication
(10) Pub. No.: US 2006/0269687 A1
(43) Pub. Date: Nov. 30, 2006

(54) Selective area fusing of a slurry coating using a laser

(75) Inventors: Warran Boyd Lineton, Ann Arbor, MI (US); Theodore John Barron, Allentown, PA (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/141,278

(22) Filed: May 31, 2005

(51) Int. Cl. B29C 71/02; B05D 3/00; B05D 5/00

(52) U.S. Cl. 427/532; 427/282; 427/189; 427/197

(57) ABSTRACT

A method of depositing thin coating layers a wide variety of coating materials on a wide variety of substrate by fusing a slurry coating of the coating material onto a coating surface of the substrate by application of energy from a laser. The coating materials and substrates may include pure metals and metal alloys, ceramics, cements, polymers and composites of these materials. The method produces a fused coating layer in a predetermined pattern by the use of a reflective mask, such as a polished metal mask of a metal that is particularly adapted to reflect the wavelengths of the laser energy used to fuse the coating. The method may be implemented as an additive process to produce the fused coating layer, or alternately, it may be implemented as an additive and subtractive process.

### BACKGROUND OF THE INVENTION

1. Technical Field

This invention relates generally to a method of fusing a slurry coating to a substrate. More particularly, it relates to a method of fusing a slurry coating to a substrate in a predetermined pattern using a laser to fuse the particles of the slurry coating and a reflective mask to define a predetermined pattern of the slurry coating.

2. Related Art

In many applications it is desirable to provide a relatively thin coating layer of a first material over a substrate of a second material. Further, it is frequently desirable to define a predetermined pattern of the thin coating layer on the substrate. Depending on the application, the selected substrate may include virtually any solid material, including metals, ceramics, glasses, cermets and composites formed from these materials. Depending on the application and the substrate, the coating layer may also be formed from virtually any solid substrate material, including those described above. Such coatings may be utilized to perform various functions or provide various characteristics, including electrical conductivity, electrical resistance, electrical insulation or isolation, thermal conductivity, thermal resistance, oxidation resistance, ablation resistance, wear resistance, defined surface topology or roughness characteristics, tribological or friction coefficient control characteristics as well as other functions or characteristics.

Many different methods exist for applying relatively thin coating layers of a wide variety of materials to a wide variety of substrates. Similarly, numerous methods also exist for forming predetermined patterns of such thin coatings layers on such substrates. Examples include the use of various thin film deposition methods, such as sputtering, thermal and electron beam evaporation, electroplating, electroless plating, electrophoresis, dipping, thermal, kinetic and plasma spraying, lamination, cladding and many others to apply a thin coating layer to a substrate either in a pattern as a result of the deposition or followed by the use of various patterning methods, such as various photolithographic and other patterning methods combined with chemical, plasma or other etching techniques, ion milling, and sputtering to name a few. Other examples include the use of various screen printing and doctor blading techniques to apply fusible particles of a coating layer to a substrate in a predetermined pattern followed by the use of various methods to apply heat sufficient to fuse the fusible particles to one another and to the substrate. Methods used to apply the thermal energy to the particles and cause them to fuse to themselves and to the substrate include, convection ovens, infrared lamps and the like. Still other methods have included various forms of cladding, such as by high temperature, high pressure rolling together of a substrate and thin coating materials so as to cause them to bond to one another.

### SUMMARY OF THE INVENTION

This invention is a method of applying a fused coating layer to a substrate by applying a slurry coating which contains fusible powder particles of the coating material to the substrate and fusing the coating material in the slurry coating to the substrate as a coating layer by application of energy from an energy source such as a laser beam. The method of the invention may be used to apply wide range of coating materials, such as various pure metals and metal alloys, ceramics, cermets, glasses and polymers, and composites thereof, to a wide range of substrate materials, which may also include various pure metals and metal alloys, ceramics, cermets, glasses and polymers, and composites and laminates of these substrate materials. The method may be used to produce a wide variety of predetermined patterns of the coating layers. In one aspect of the invention, the method includes the steps of selecting a substrate having a coating surface, applying a coating of a slurry comprising fusible particles to the coating surface, placing a mask over the coating surface to define a predetermined pattern of the slurry coating and applying energy from a laser to the predetermined pattern of the slurry coating sufficient to cause at least a portion of the fusible particles within the predetermined pattern to fuse to the substrate. The method may also incorporate a step of drying the slurry following the step of applying the slurry coating. In implementations of the method where not all of the fusible particles of the slurry coating are fused by the step of applying the laser energy, the method may also incorporate a step of removing the fusible particles which are not fused by the step of applying the laser energy. In a second aspect of the invention, the order of the steps of the method described above may be altered such that the step of placing a mask over the coating surface to define a predetermined pattern of the slurry coating precedes the step of applying a coating of the slurry comprising fusible particles to the coating surface. In this aspect of the invention, the alternate steps referred to above may also be implemented with suitable difference to the fact that the order of the steps of placing the mask and applying the slurry coating have been rearranged. The method of the invention is particularly advantageous in that it enables the deposition of a wide variety of coating materials on a wide variety of substrates in a wide variety of predetermined patterns through the use of a single coating method, by suitable adaptation of the deposition parameters appropriate to the particular slurry coating and substrate materials selected.

It is a further advantage of the method of the invention that the predetermined pattern of the coating layer may be fused to the substrate in a purely additive manner, and that if subtractive processes are required to remove unfused portions of the slurry coating, that the amount of material which must be removed can be controlled so as to minimize or greatly reduce the amount of material which must be removed using subtractive processes.

### BRIEF DESCRIPTION OF THE DRAWINGS

These and other features and advantages of the present invention will become more readily appreciated when considered in connection with the following detailed description and appended drawings, like elements in the figures are given like designations, and wherein:

FIG. 1 is a top view of a substrate according to a first exemplary embodiment of the invention;

FIG. 2 is a cross-sectional view taken along section lines 2-2 in FIG. 1;

FIG. 3 is a top view of the substrate shown in FIG. 1 after a slurry coating has been applied to a coating surface of the substrate;

FIG. 4 is a cross-sectional view taken along section lines 4-4 in FIG. 3;

FIG. 5 is a top view of the substrate and a mask covering a portion of the slurry coating;

FIG. 6 is a cross-sectional view taken along section lines 6-6 in FIG. 5;

FIG. 7 is a top view of the substrate and the mask after energy has been directed to a portion of the slurry coating;

FIG. 8 is a cross-sectional view taken along section lines 8-8 in FIG. 7;

FIG. 9 is a top view of the substrate after the mask has been removed;

FIG. 10 is a cross-sectional view taken along section lines 10-10 in FIG. 9;

FIG. 11 is a top view of the substrate with a fused coating;

FIG. 12 is a cross-sectional view taken along section lines 12-12 in FIG. 11;

FIG. 13 is a first side view of a substrate and energy from a laser cooperating to begin scanning a slurry coating in a second embodiment of the invention;

FIG. 14 is a second side view of the substrate and deposition of energy during scanning;

FIG. 15 is a third side view of the substrate and the energy at the end of the scan;

FIG. 16 is a detail view of a third exemplary embodiment of the invention wherein a slurry coating is disposed in a recess; and

FIG. 17 is a side view of a fourth exemplary embodiment of the invention wherein a mask is recessed relative to a slurry coating.

### DETAILED DESCRIPTION OF THE PREFERRED EMBODIMENT

A plurality of different embodiments of the invention are shown in the Figures of the application. Similar features are shown in the various embodiments of the invention. Similar features have been numbered with a common two-digit reference numeral and have been differentiated by a third digit placed before the two common digits. Also, to enhance consistency, features in any particular drawing share the same third digit designation even if the feature is shown in less than all embodiments. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

The invention provides a method of applying a fused coating layer to a substrate by applying a slurry which contains fusible powder particles of the coating material to the substrate and fusing the coating material in the slurry to the substrate as a coating layer by application of an energy from an energy source, such as a laser beam. The method may be used to apply a wide range of coating materials, such as various pure metals and metal alloys, ceramics, cermets, glasses and polymers, and composites thereof, to a wide range of substrate materials, which may also include various pure metals and metal alloys, ceramics, cermets, glasses and polymers, and composites and laminates of these substrate materials. Further, the method may be used to produce a wide variety of predetermined patterns of the coating layers.

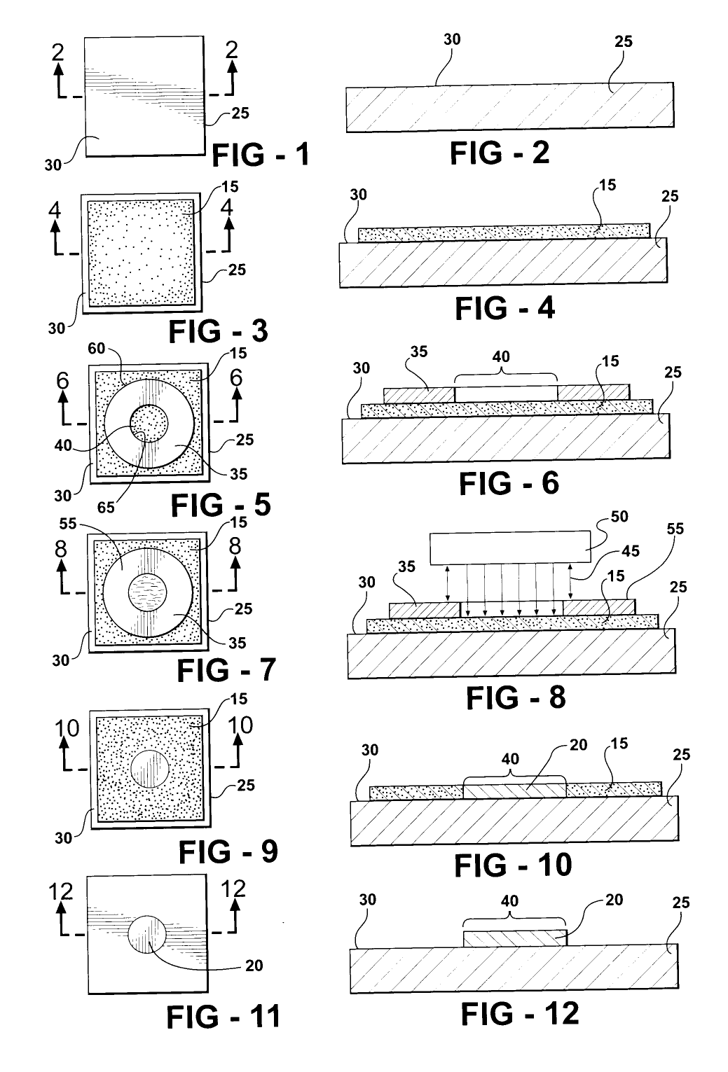

FIGS. 1-12 illustrate steps in an exemplary process for practicing the invention wherein a slurry coating 15 is fused on a coating surface 30 of a substrate 25 to form a coating layer 20. FIGS. 1 and 2 show the substrate 25. The substrate 25 may be selected from any suitable solid material, including metals, ceramics, glasses, cermets and polymers. Substrate 25 may also include various laminated or other composites of these materials. The substrate material selected will depend of the application of substrate 25.

Substrate 25 may have any suitable size and shape or form, from flat sheets or plates of various sizes and thicknesses to various other two-dimensional and three dimensional shapes of various sizes and forms. This may also include various forms of stepped, curved or other surfaces. Likewise, coating surface 30 may have any desired size and shape or form.

Coating surface 30 may include a single flat surface of substrate 25 or may comprise multiple surfaces, including various two-dimensional and three dimensional surfaces of various sizes and forms. The coating surface 30 of substrate 25 may have a controlled surface finish or roughness depending on the application requirements of substrate 25, coating layer 20 and other factors.

Therefore, the substrate 25 may be fabricated, processed and/or designed based on choices related to the material, size, shape or other aspects depending on the desired application and application environment. The exemplary substrate 25 is a flat plate or sheet of a metal, such as a sheet of steel.

Referring now to FIGS. 3 and 4, a slurry coating 15 is applied to the surface 30. The exemplary slurry coating 15 is formed from fusible particles. As used herein, a slurry is defined most generally as a mixture of fusible particles in a fluid carrier medium. The fusible particles may comprise any suitable fusible solid material, including metals, ceramics, glasses, cermets and polymers, as well as composites thereof. The mixture is preferably in the form of a stable or meta-stable suspension of the fusible particles in the fluid carrier medium.

Generally, it is preferred that fusible particles comprise greater than or equal to about 75% by weight of the slurry. The percentage of fusible particles can be less than 75% as well. The fluid carrier medium may include any number of constituents which provide a desired benefit and the formation of coating layer 20. The fluid carrier medium may be primarily water-based, in which case the slurry will be water an aqueous based slurry.

Alternately, the fluid carrier medium may include an organic solvent, such as various alkanes, alkenes, alcohols, ketones, glycols, esters, ethers, aldehydes, pyridines and the like, in which case the slurry will be an organic slurry. The fluid carrier medium will also act as or include as a separate constituent, whether in solution or otherwise, a binder material.

The binder material coats and provides cohesion between the plurality of fusible of particles and between the fusible particles and the substrate 25. The binder is operative to bind the particles by any of a number of well-known binding mechanisms into a coherent layer. For aqueous slurries comprising a number of types of metal powder particles, including those which included various combinations of Pt group noble metal powder particles and refractory metal powder particles, as well as Ni, Co, Cr, Al, Y alloy powder particles, polyvinyl alcohol can be a binder. The slurry coating 15 may also include other constituents to perform or provide various other functions, including rheology modifiers, biocides, fungicides, surfactants and fluxes.

Rheology modifiers, such as thickening agents, can be used to adjust the viscosity and other flow characteristics of the slurry medium 15 consistent with the method used to apply the slurry. For example, for some application methods it may be desirable to have a rheology which provides a free-flowing liquid consistency for the fluid carrier medium, while in other applications it may be desirable that fluid carrier medium have a rheology or consistency more like that of a thick film paste. For slurries comprising various metal powders of the types described above, xanthan gum can be an effective rheology modifier as a thickening agent.

In addition to binders and rheology modifiers, the slurry coating 15 may also include various biocides and fungicides to prevent microbial and fungal growth during storage of the slurry and lengthen the shelf life of the slurry. For aqueous slurries comprising various metal powders of the types described above as the fusible particles, methylparaben can be an effective anti-microbial and antifungal agent.

The slurry coating 15 may also include a surfactant or plurality of surfactants to promote the wetting of the fusible powder particles. The surfactant can be selected based on the other constituents, particularly the solvent, binder material and the fusible particles. The surfactant may be selected from well known surfactant materials, including both ionic and non-ionic surfactant materials, depending on the application and the nature of the fusible particles and the fluid carrier medium. For some types of fusible particles, it may also be desirable to utilize a flux to promote the fusing of the particles or to protect the particles from oxidation during fusing. The flux may also be selected from well known flux materials depending on the application and the nature of the fusible particles and the fluid carrier medium.

The slurry coating 15 may be applied using any suitable application technique or method depending on the requirements associated with the substrate 25 and slurry coating 15. The slurry coating 15 may be applied using painting, spraying, dip coating, doctor blading, transfer printing, and screen printing of the slurry onto the substrate.

Referring now to FIGS. 5 and 6, a mask 35 is placed over the coating surface 30 to define a predetermined pattern 40 of the slurry coating 15. The mask 35 can be used to define the portion of the coating surface 30 that will be coated with the slurry coating 35. Alternately, the mask 35 can be placed over the slurry coating 15 after the slurry coating 15 has been applied on the coating surface 30.

The slurry coating 15 can be dried prior to applying the mask 35 in order to remove all or a substantial portion of the fluid carrier medium. Drying may be performed using any suitable means or method, including drying at room temperature either in air or in a non-oxidizing atmosphere, such as nitrogen or argon, and also including drying at an elevated temperature using well-known methods and means such as various types of ovens, furnaces, infrared lamps and the like.

The mask 35 may be made from any suitable material that is capable of defining the predetermined pattern 40. The mask 35 allows energy 45 (to be described in greater detail below) to be applied to a first portion of the slurry coating 15 and prevents energy 45 from being applied a second portion of the slurry coating 15. The mask 35 can protect the second portion of the slurry coating 15 by either absorbing the energy 45 or by reflecting the energy 45 or by a combination of deflection and absorption.

If the mask 35 is operable to absorb some of the energy 45, the mask 35 can be adapted to absorb some of the energy 45 without melting and/or without fusing to the coating surface 30. If the mask 35 absorbs some of the energy 45, the mask 35 can be adapted to reflect as much of the energy 45 as possible. The mask 35 can be made from copper or aluminum alloys, pure copper, pure aluminum, for example. A surface 55 of the mask 35 be polished to enhance the reflectance of the mask 35.

The predetermined pattern 40 may be of any desired size or shape. The mask 35 has a perimeter 60 and an opening 65. The mask 35 can have a plurality of openings which cooperate to define the predetermined pattern 40. The predetermined pattern 40 may include an area of the slurry coating 15 outside of the perimeter 60 of mask 35, or inside of the perimeter 60 of mask 35, or both inside and outside of the perimeter 60 of mask 35.

Referring to FIGS. 7 and 8, energy 45 in the form of light energy from a laser 50 is applied to the predetermined pattern 40 of the slurry coating 15. The energy 45 is sufficient to cause at least a portion of the fusible particles of slurry coating 15 within the predetermined pattern 40 to fuse to one another and to the coating surface 30 of the substrate 25.

Referring to FIGS. 9 and 10, after the energy 45 has been applied to the slurry coating 15 in the predetermined pattern 40, particles of slurry coating 15 are fused to one another to form the fused coating layer 20. The energy 45 of the laser 50 may be applied using known laser irradiation techniques, depending on the size and shape of the predetermined pattern 40 which is to be irradiated, the required throughput of the process and other factors. These techniques may include, for example, the radiation of a single spot or area without relative movement of the laser 50 or coating surface 30 of the substrate 25, or rastering of the laser 50 over the coating surface 30 of the substrate 25 in a serpentine or other raster configuration, or scanning of at least one of the laser 50 and substrate 25 relative to one another. The mask 35 and substrate 25 can be rotated relative to the laser 50 in another embodiment of the invention. The advantage of rotating mask 35 and substrate 25 relative to the laser 50 is the ability to control the exposure of a circular shape of predetermined pattern 40.

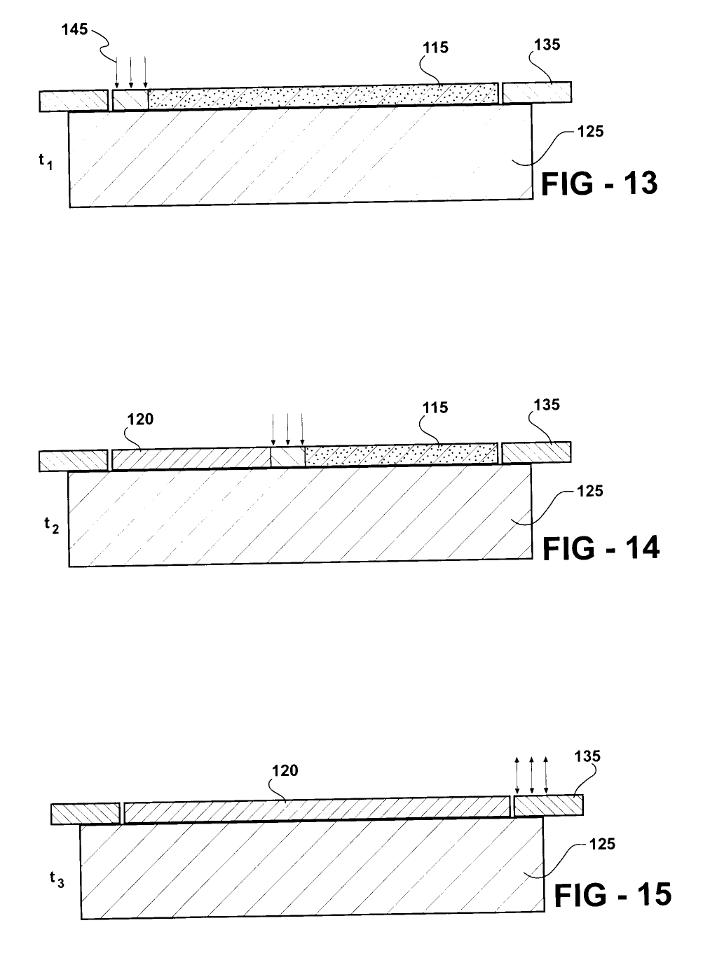

When scanning is employed, one of substrate 25 or the laser 50 is moved relative to the other as a function of time until all of the predetermined pattern 40 is exposed to the laser 50. Referring to FIGS. 13-15, a substrate 125 is coated with a slurry coating 115 encircled by a mask 135. A laser (not shown) directs energy 145 toward the substrate 125. As time passes from t₁ to t₃, one of the laser and the substrate 125 moves relative to the other such that the slurry coating 115 is changed to a fused coating 120 by the energy 145.

For slurry coatings 15 comprising many pure metals and metal alloys, a multi-kilowatt, direct diode laser can be used. When utilizing direct diode lasers, the energy 45 of laser 50 can have a power density of less than about 10⁵ watts/cm² and interaction time of 10⁻¹ seconds or less to avoid overheating or vaporization of either of the fusible particles of the slurry coating 15 or substrate 25. The cross-sectional shape of the beam of the laser may be any suitable shape depending on the combination of the slurry coating 15 and substrate 25 being used, as well as the size and shape of predetermined pattern 40. In the case where substrate 25 is a metal and slurry coating 15 comprises metal powder particles, use of a scanned beam having a rectangular cross-sectional shape with a width and length in the range of about 10.0-15.0 mm and 0.5-2.0 mm, respectively, can be used.

In one embodiment of the invention, the particles of slurry coating 15 are reflowed and the resulting liquid within portion 16 resolidifies to form coating layer 20 (e.g. many metals and pure metal alloys). In some cases, such as slurry coatings 15 comprising many pure metal and metal alloy powder particles, it is desirable to apply sufficient energy to reflow substantially all of the powder particles which upon subsequent resolidification form a homogeneous coating layer 20 of a pure metal or metal alloy, respectively. Similarly, if slurry coating 15 comprises a mixture of different pure metal powder particles in relative amounts which correspond to a desired alloy composition, it is desirable to apply sufficient energy to reflow substantially all of the powder particles which upon subsequent resolidification form a homogeneous coating layer 20 of the desired metal alloy composition. In other cases, such as where the slurry coating 15 comprises various polymer particles, or a mixture of polymer particles and other particles such as metal powder particles in a polymer/metal composite, or a slurry of a relatively low melting point pure metal or metal alloy and a relatively high melting pure metal or metal alloy, it is believed that it may not be desirable to completely melt or soften all of the particles of the slurry, but rather to apply sufficient energy to reflow, or in the case of polymers sufficiently soften, only a portion of the particles so as to cause them to fuse to one another and to the substrate. This would be particularly applicable where the reflow of one of the slurry constituents (e.g., a high melting point metal) might cause an undesirable amount of heating of another constituent of the slurry coating (e.g., a polymer), particularly if the energy level required to melt the higher melting point material metal might cause chemical decomposition, excessive vaporization or other degradation of the lower melting point constituent. In such cases, powder particles of a higher melting point or softening point material may not be reflowed, or softened sufficiently to cause them to be fused to one another, but they may, for example, be utilized to absorb the energy 45 of laser 50 and promote the softening of the lower melting point or softening point powder particles.

As an example of the various types of slurries described above, in the case where fusible particles comprise metal powder particles of a single pure metal (e.g., noble metals such as Pt, Ir, Rh, Pd or other metals such as Hf, Ta, W, Re) or a homogeneous metal alloy composition (e.g., particles of a Pt—Ir alloy), or even a mixture of different pure metal powder particles in relative amounts which correspond to a desired alloy composition (e.g., a mixture of relative amounts of pure metal powders of Ni, Co, Cr, Al and Y sufficient to form one of a number of well-known NiCoCrAlY alloys), it may be desirable to reflow all of the fusible particles of the slurry to form, upon subsequent resolidification, a coating layer 20 of a homogeneous pure metal or metal alloy. Alternately, in an example where fusible particles have significantly different melting point (e.g., many polymer/metal slurries, as well as many ceramic/metal or polymer slurries), it may be desirable to selectively melt or soften one or more of the powder constituents preferentially to the other constituents, so as to promote limited fusing of the powder particles to one another and to the substrate, such as frequently occurs in a sintering process.

Referring to FIGS. 11 and 12, any fusible particles which are not fused by the energy of the laser are removed from the surface 30. This may be performed using any suitable method, including dissolving or rinsing unfused slurry coating 15 from coating surface, or using mechanical methods, such as various scrubbing, spraying abrasive methods or other well-known methods of removing the non-fused coating material, or various combinations of these methods.

The steps set forth above may be repeated for a given substrate 25 so as to provide more than one predetermined pattern 40 of a coating material 20 onto a given substrate 25 or to provide a plurality of coating layers 20. If a plurality of coating layers 20 are deposited, each layer 20 may be deposited on a single coating surface 30 or multiple coating surfaces of substrate 25. They may be deposited as different portions of a single layer, or as a multi-layer stack of coating materials, such as a stack of conductor layers separated by various dielectric layers. As will be appreciated, the combinations and permutations of coating layers that may be applied to a substrate, either as single layers or as multi-layer stacks are numerous.

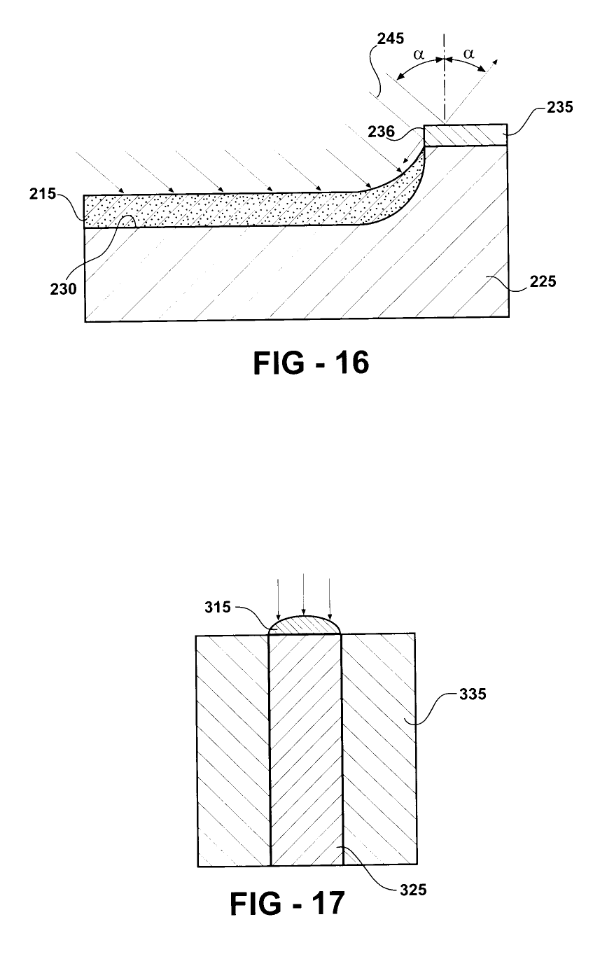

Referring now to FIG. 16, in a third exemplary embodiment of the invention, a slurry coating 215 may be in a different plane than a mask 235. The slurry coating 215 can be deposited into an indentation or recess in the surface 230 of substrate 225. The mask 235 can be located either above or below the plane of slurry coating 215. An incident angle α of energy 245 can be varied from normal with the beneficial effect that portions of the energy 45 front may be reflected from sidewalls 236 of the mask 235 into the slurry coating 215 to further assist in the fusing of the particles of slurry coating 215. Thus, it may be desirable to vary the angle of incidence of the energy source 45 to improve the energy transfer.

Referring now to FIG. 17, in a fourth exemplary embodiment of the invention, a mask 335 is located below a slurry coating 315 as energy 345 is applied to the slurry coating 315.

Obviously, many modifications and variations of the present invention are possible in light of the above teachings. It is, therefore, to be understood that within the scope of the appended claims, the invention may be practiced otherwise than as specifically described.

What is claimed is:

1. A method of fusing a slurry coating to a substrate, comprising the steps of:
selecting a substrate having a coating surface;
applying a coating of a slurry comprising fusible particles to the coating surface;
placing a mask over the coating surface to define a predetermined pattern of the slurry coating; and
applying energy from a laser to the predetermined pattern of the slurry coating sufficient to cause at least a portion of the fusible particles within the predetermined pattern to fuse to the substrate.

2. The method of claim 1, further comprising the step of:
removing the mask from the coating surface subsequent to the step of applying energy from a laser.

3. The method of claim 1, further comprising the step of:
drying the slurry following said step of applying a coating of the slurry.

4. The method of claim 1, wherein the slurry coating comprises fusible particles which are not fused by said step of applying the laser energy, further comprising a step of:
removing the fusible particles which are not fused by said step of applying the laser energy.

5. The method of claim 1, wherein said step of applying the coating of the slurry comprises at least one of painting, spraying, dip coating, doctor blading, transfer printing, and screen printing of the slurry onto the substrate.

6. The method of claim 1, wherein the substrate is selected from a group consisting of: metals, ceramics, cermets, glasses, polymers and composites thereof.

7. The method of claim 1, wherein the slurry comprises a binder.

8. The method of claim 6, wherein the binder comprises polyvinyl alcohol.

9. The method of claim 1, wherein the slurry also comprises at least one of a rheology modifier, biocide, fungicide and surfactant.

10. The method of claim 1, wherein the slurry comprises greater than or equal to 95 percent by weight of the fusible particles.

11. The method of claim 1, wherein the slurry is an aqueous slurry.

12. The method of claim 1, wherein the slurry is an organic slurry.

13. The method of claim 1, wherein the fusible particles are selected from a group consisting of: metals, ceramics, cermets, glasses, polymers and composites thereof.

14. The method of claim 1, wherein the mask has a perimeter and the predetermined pattern is located without the perimeter of the mask.

15. The method of claim 1, wherein the mask has a perimeter and the predetermined pattern is located within the perimeter of the mask.

16. The method of claim 1, wherein the mask has a perimeter and the predetermined pattern is located both within and without the perimeter of the mask.

17. The method of claim 1, wherein the mask is operative to reflect the energy of the laser.

18. The method of claim 17, wherein the mask comprises a metal.

19. The method of claim 18, wherein the metal is aluminum or copper.

20. The method of claim 1, wherein the laser is a direct diode laser.

21. The method of claim 20, wherein the laser has a beam having a rectangular cross-sectional shape.

22. The method of claim 21, wherein the beam has at focus a rectangular cross-sectional shape having a width and a length which range from about 10.0-15.0 mm and about 0.5-2.0 mm, respectively.

23. The method of claim 22, wherein the laser energy is applied to the substrate with a power density of about 10 watts/cm² and interaction time of 10⁻¹ seconds or less.

24. The method of claim 1, wherein said step of applying energy from a laser comprises scanning at least one of the beam and the substrate such that the laser energy is applied over the predetermined pattern.

25. The method of claim 1, wherein said step of applying energy from a laser comprises rotating at least one of the beam and the substrate such that the laser energy is applied over the predetermined pattern.
